(19) United States
(12) Patent Application Publication
(10) Pub. No.: US 2003/0110451 A1
(43) Pub. Date: Jun. 12, 2003

(54) Practical chinese classification input method

(76) Inventors: Sayling Wen, Taipei (TW); Zechary Chang, Taipei (TW); Leger Wu, Beijinh (CN)

Correspondence Address: BIRCH STEWART KOLASCH & BIRCH, PO BOX 747, FALLS CHURCH, VA, 22040-0747, US

(21) Appl. No.: 10/003,440

(22) Filed: Dec. 6, 2001

(51) Int. Cl. G06F 15/00

(52) U.S. Cl. 715/536

(57) ABSTRACT

A practical Chinese classification input method of the invention classifies word, phrase, and sentence input methods and searches a database in real-time to find data quickly and accurately and display it dynamically. At the same time, by special design of tones input and candidate data shortcut keys, an input frame and a candidate word frame can coexist in a picture to substantially increase the amount of candidate data that can be displayed and increase the speed of Chinese character inputting. Meanwhile, the function of an expandable phrase and sentence database is provided to reduce the amount of time needed for inputting when the same content is repeatedly required.

### BACKGROUND OF THE INVENTION

1. Field of the Invention

The invention relates to a Chinese input method used in a computer system, and more particularly, to a practical Chinese classification input method.

2. Related Art

Chinese inputting is a forbidding task for those whose daily job involves processing a lot of word data inputting. Input speed is a major subject of concern.

Various Chinese input methods have appeared and are now used. These prior art input methods speed up inputting through special methods of taking apart words to solve the problem of input speed, such as the Cang-Jia input method or the Wu-Xia-Mi input method. For these input methods, users must spend a long time training themselves how to use them and memorizing their special methods of taking apart and inputting characters. For common users, this is a very difficult task, and it is more suitable for professional people who have been trained.

Moreover, Chinese input methods in the prior art do not classify the input contents for users first. After the users' input, through database searching the candidate data appears as mixed-up words, phrases, and sentences. Therefore, selection is quite inconvenient and it negatively affects input efficiency. Meanwhile, the amount of candidate data is greatly reduced, so candidate data frames must be switched often and more time is wasted. With traditional input methods the numbers 1˜5 are often used for selecting the candidate data, so a tone input frame and a candidate data frame cannot coexist at the same time, which makes the process of selection even more inconvenient for users.

Of course, the phrase database in all input methods may not be sufficient to meet the requirements of all users. However, common prior art input methods extend the database through another extensive database input interface of the input method, but they do not extend the database while inputting in real-time. This is also inconvenient for users and it lacks efficiency.

### SUMMARY OF THE INVENTION

A primary objective of the invention is therefore to provide a Chinese input method to solve the above mentioned problems.

The practical Chinese classification input method of the invention involves classifying according to different input contents to accelerate Chinese inputting. The method comprises: (1) starting an input interface and selecting an input mode to perform inputting; (2) receiving input data content to perform a database comparison operation; and (3) searching candidate data for selecting.

The advantages of the invention are that it provides a simple means of input, accelerates Chinese inputting, and extends its database in real-time.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow. However, the following description is for purposes of illustration only, and thus is not limitative of the invention, wherein:

FIG. 1 is an entire flow chart of the practical Chinese input method of the invention.

FIG. 2-a is a main operation flow chart of the practical Chinese input method of the invention.

FIG. 2-b is a main operation flow chart of the practical Chinese input method of the invention.

FIG. 2-c is a main operation flow chart of the practical Chinese input method of the invention.

FIG. 3 is a diagram of a function interface and an input mode interface of the practical Chinese input method of the invention.

FIG. 4 is a diagram of an input frame and a candidate word frame coexisting in inputting Pin-Yin phonetic transcriptions of the practical Chinese input method of the invention.

FIG. 5 is a diagram of an input frame and a candidate word frame coexisting in inputting Zhu-Yin phonetic notations of the practical Chinese input method of the invention.

### DETAILED DESCRIPTION OF THE INVENTION

The invention provides a practical Chinese classification input method for users to search data contents from a database in the least amount of time to improve the speed and efficiency of inputting Chinese characters. Meanwhile, the function of an expanding phrase database is provided for users to be able to input more quickly when encountering the same phrases and sentences in the future.

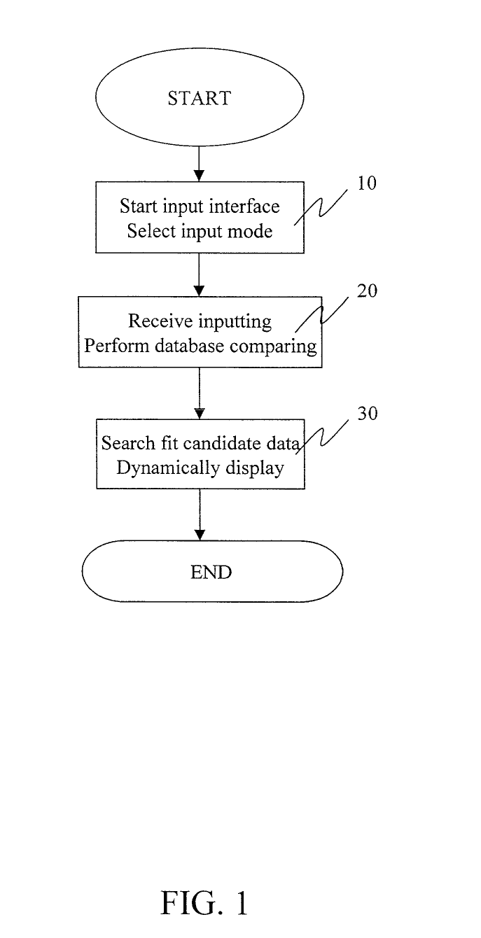

The invention provides a preferred embodiment to describe the feasibility of the method of the invention. FIG. 1 is an entire flow chart of the practical Chinese input method of the invention. It describes the main flow of the practical Chinese classification input method. The steps are:

First, a user must start the Chinese input method and open an input interface before select an input mode (step 10). If the user does not switch the input mode, the input method predetermines the input mode as and interface of “word input mode”. Next, the system receives user input and transfers to the database to perform comparison (step 20). Finally, it displays the searched candidate data from the database dynamically (step 30) to provide the user a list from which to select the needed items.

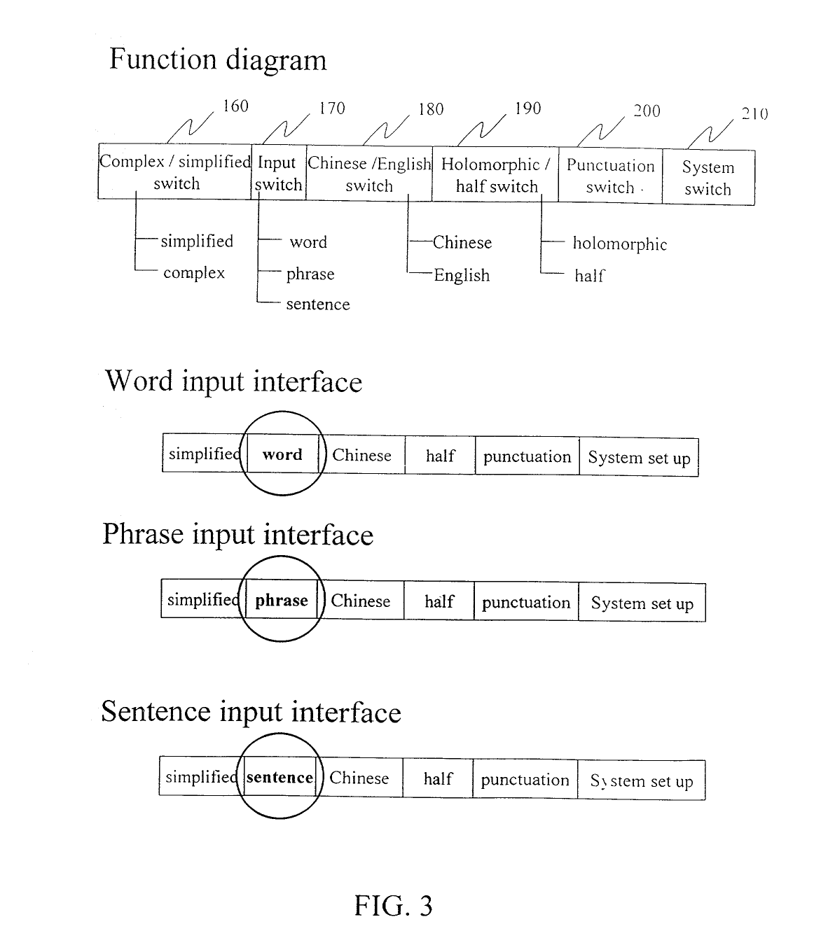

When the input method is used, the user should see an input method function interface as shown in FIG. 3. From this diagram, we can see that the input method comprises the following basic functions: (1) complex/simplified switch function 160, (2) input mode switch function 170, (3) Chinese/English switch function 180, (4) holomorphic/half switch function 190, (5) punctuation switch function 200, and (6) system setup switch function 210. When the user performs any function switch operations, s/he knows the function status of the present input method according to the display contents of each function area on the input method function interface.

Switching the input mode is described as follows. The second part of FIG. 3 illustrates the process of selecting the input mode as “word input mode”. The display content of the area of the input mode switch function 170 (i.e. the black circle) is “word”. This indicates that the input method performs inputting in a word mode. The third and fourth parts of FIG. 3 illustrate the processes of switching to “phrase input mode” or “sentence input mode”, respectively. The display contents of the area of the input mode switch function 170 (i.e. the black circle) are “phrase” or “sentence”, respectively, to represent the status of the input method.

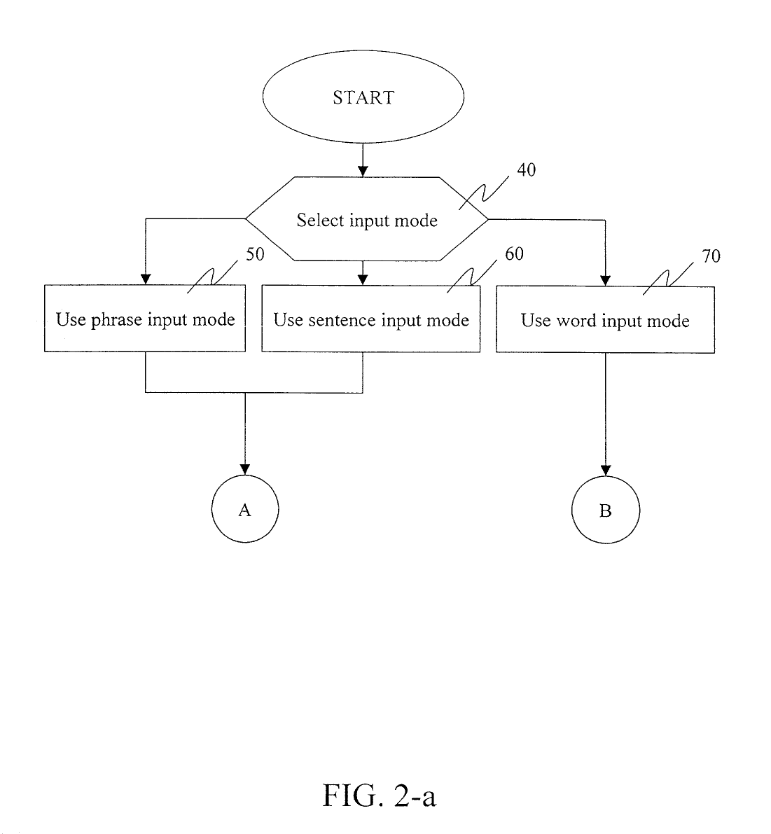

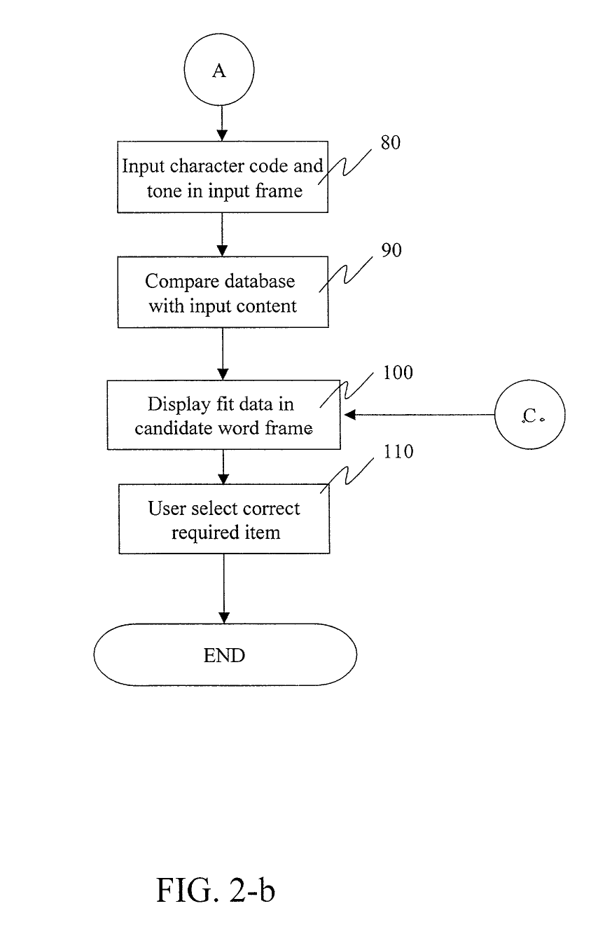

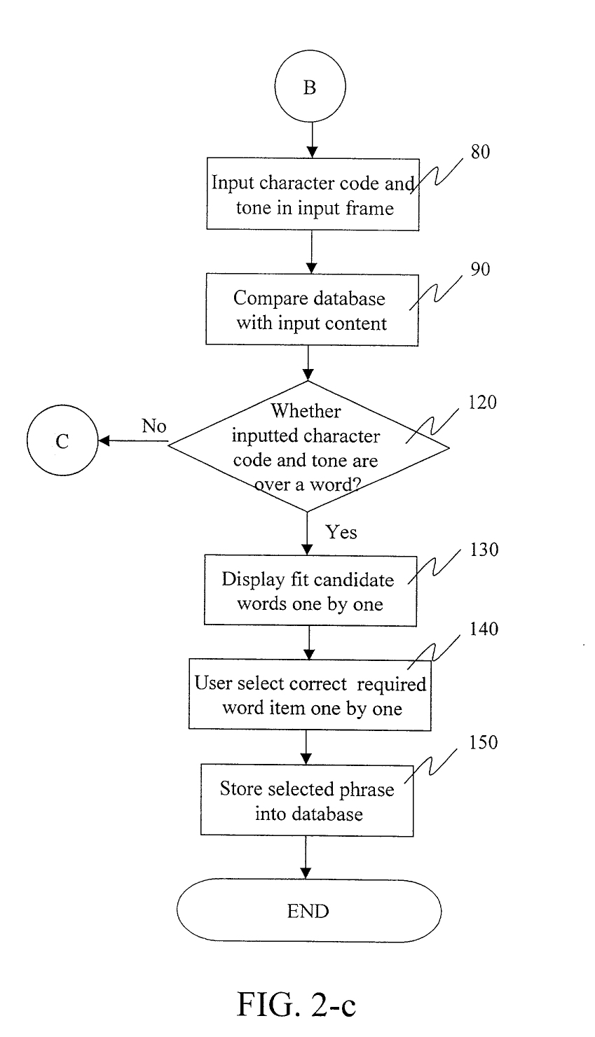

Please refer to FIGS. 2-a, 2-b, and 2-c. These figures are a main operation flow chart of the practical Chinese input method of the invention. And illustrate different operating steps according to different input modes as follows:

After a user actives the input interface of the input method, s/he selects an input mode (step 40). The input method predetermines an input mode as “word input mode” (step 70). For the user selecting a different input mode, refer to FIG. 2-c. The user can start to input the correct character codes and tones of the needed Chinese words in the input frame (step 80). The input method then compares the input contents with data in the database (step 90). And then return to FIG. 2-b. The input method displays all data in the database that fits the word in the candidate word frame (step 100), and the user selects the correct item through the shortcut keys (step 110). However, if the user uses the “word input mode”, when s/he finishes inputting the character codes and tone of a word, a comparison and a display for selecting are performed. However, at this time, if the user continues inputting character codes and tones of other words, i.e. inputting more than one word (step 120), the “word input mode” of the input method automatically determines that the inputting operation belongs to an operation of storing phrases, actives a storage function, and displays every suitable candidate words one by one (step 130). The user can then select the correct word items one by one (step 140). Finally, selected phrases or sentences are stored into the database (step 150) for future inputting. If the user selects “phrase input mode” (step 50) or “sentence input mode” (step 60), the flow goes to FIG. 2-b. The user can input correct character codes and tones of the phrases or sentences in the input frame (step 80). The input method then compares the input contents with the data in the database (step 90). After that, it displays all suitable data contents in the database in the candidate word frame (step 100). The user selects the correct items through the shortcut keys (step 110).

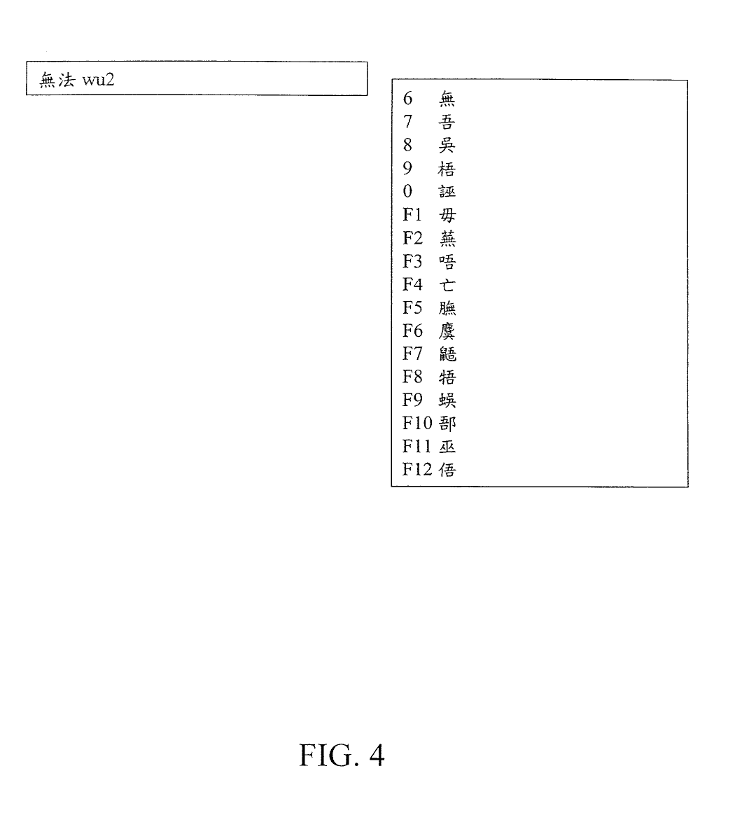

Next, please refer to FIG. 4, which is a diagram of an input frame and a candidate word frame coexisting in inputting Pin-Yin phonetic transcriptions of the practical Chinese input method of the invention.

FIG. 4 illustrates phonetic alphabets and tones coexisting in the left-half input frame of the diagram. In the invention, the first tone, second tone, third tone, fourth tone, and soft tone are represented by the numbers 1˜5, respectively. In the right-half input frame of the diagram 17 pieces of data can be displayed simultaneously, and each piece of data can be selected through the shortcut keys set by the input method. The shortcut keys in the invention comprise 17 keys: the number keys 6˜0 and the function keys F1˜F12. Furthermore, in the present invention, the numbers used for inputting tones in the input frame are distinguished from the shortcut keys used for selecting candidate data in the candidate word frame. Thus, the invention can generate a special input method of the input frame and the candidate word frame that coexist in the same picture.

Moreover, FIG. 4 illustrates that when the user performs inputting, the input method of the invention displays suitable input contents in the candidate word frame in real-time, and replaces searching conditions in the database based on the input to determine suitable data contents more quickly for users to improve selection efficiency. The searching method of the database involves comparing the first phonetic symbol of each word inputted by the user. For example, when the user inputs “w”, the database takes “w” as a searching condition. When the user inputs “wu f”, the input method performs a search based on the first phonetic symbol of the two inputted words, “w” and “f”.

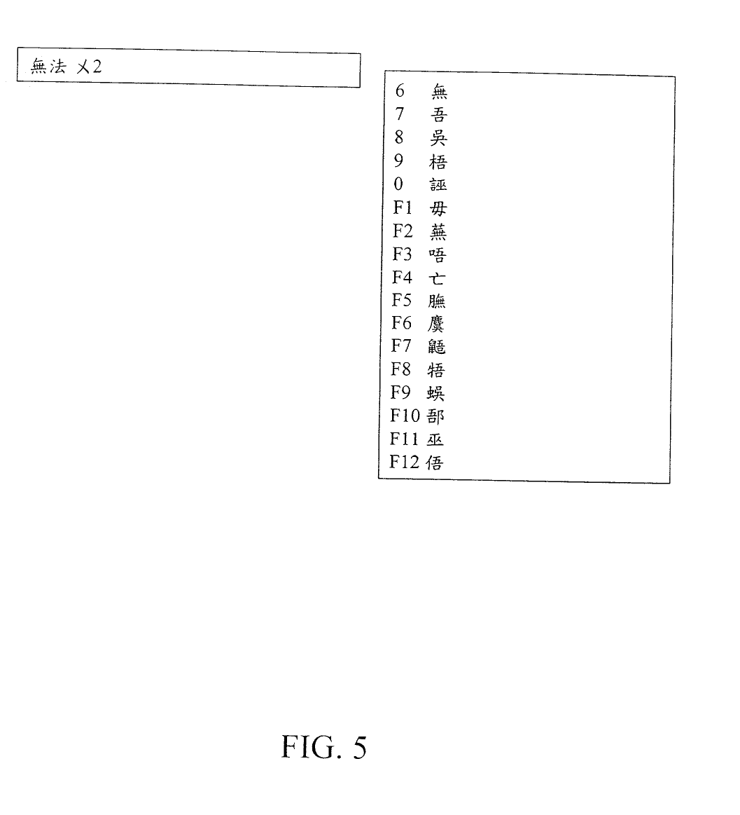

Finally, please refer to FIG. 5, which is a diagram of an input frame and a candidate word frame coexisting in inputting Zhu-Yin phonetic notations of the practical Chinese input method of the invention. It achieves the same objective as the same operating flows and details as shown in FIG. 4 under a function mode of Zhu-Yin phonetic notation input.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A practical Chinese classification input method for classifying according to different input contents to speed up Chinese inputting; the method comprises:
starting an input interface and selecting an input mode to perform inputting;
receiving inputting an input data content to perform a database comparing operation; and
searching a fit candidate data for selecting.

2. The practical Chinese classification input method of claim 1 wherein the input interface comprises a simplified/complex function, an input function, a Chinese/English function, a holomorphic/half function, a punctuation marks switch, and a system set up switch function interface.

3. The practical Chinese classification input method of claim 1 wherein the input mode comprises a word input mode, a phrase input mode, and a sentence input mode switched by a user.

4. The practical Chinese classification input method of claim 3 wherein the word input mode further comprises:
inputting a character code and a tone to perform inputting comparison;
determining whether the input exceeds a word;
displaying fit candidate words one by one and selecting correct required words; and
storing the final selected phrase into a database.

5. The practical Chinese classification input method of claim 4 wherein the type of the character code comprises a Pin-Yin phonetic transcription encoding method and a Zhu-Yin phonetic notation encoding method.

6. The practical Chinese classification input method of claim 3 wherein the phrase input mode further comprises:
inputting the character code and the tone to perform data content comparison; and
displaying fit candidate data;
selecting correct required items.

7. The practical Chinese classification input method of claim 1 wherein the inputting data content is inputted in an input frame and comprises at least one word.

8. The practical Chinese classification input method of claim 6 wherein the word is composed of the character code and the tone.

9. The practical Chinese classification input method of claim 7 wherein a first tone, a second tone, a third tone, a fourth tone, and a soft tone of the tone are substituted by inputting numbers 1, 2, 3, 4, 5, respectively.

10. The practical Chinese classification input method of claim 1 wherein the database comparing operation compares and searches a first phonetic alphabet of each word in the inputted data in real-time.

11. The practical Chinese classification input method of claim 1 wherein the fit candidate data is displayed dynamically in real-time with a candidate word frame.

12. The practical Chinese classification input method of claim 10 wherein the candidate word frame displays 17 pieces of candidate data every time and is selected by a shortcut key.

13. The practical Chinese classification input method of claim 11 wherein the shortcut key is composed of number keys 6˜0 and function keys F1˜F12.

14. The practical Chinese classification input method of claim 1 wherein the input frame and the candidate word frame can coexist in a same picture.
